(19) United States
(12) Patent Application Publication
(10) Pub. No.: US 2010/0139898 A1
(43) Pub. Date: Jun. 10, 2010

(54) PRESSURE-ADJUSTABLE MULTI-TUBE SPRAYING DEVICE

(75) Inventors: Kuo-Shu HUNG, Hsinchu (TW); Chung-Che LIU, Hsinchu (TW); Chia-Hung LIU, Hsinchu (TW); Shih-Chang CHIANG, Hsinchu (TW); Chin-Hung LO, Hsinchu (TW); Hsu-Cheng CHIANG, (US)

Correspondence Address: RABIN & Berdo, PC, 1101 14TH STREET, NW, SUITE 500, WASHINGTON, DC, 20005, US

(73) Assignee: INDUSTRIAL TECHNOLOGY RESEARCH INSTUTUTE, Hsinchu Hsien (TW)

(21) Appl. No.: 12/417,830

(22) Filed: Apr. 3, 2009

(30) Foreign Application Priority Data
Dec. 4, 2008 (TW) 097147066

(51) Int. Cl. F28B 1/00; F28D 7/00; B05C 1/00

(52) U.S. Cl. 165/110; 165/160; 239/128

(57) ABSTRACT

A multi-tube spraying device is provided. The multi-tube spraying device includes a body having a closed vessel, wherein a plurality of spraying tubes are disposed in the upper part of the closed vessel and a plurality of heat exchanging tubes are disposed in the lower part of the closed vessel. The device further includes an outlet pipe for discharging refrigerant vapor contained therein and a connecting pipe for introducing the refrigerant vapor from a source to the vessel. In addition, a liquid-vapor separator connected to the refrigerant source separates the refrigerant into vapor and liquid for introducing the liquid refrigerant to the spraying tubes in the vessel while introducing the refrigerant vapor into the vessel. Therefore, a heat exchange is performed between the refrigerant and the heat exchanging tubes.

### BACKGROUND OF THE INVENTION

1. Field of the Invention

The present invention relates to a multi-tube spraying device, and more particularly, to a multi-tube spraying device used in a heat exchanger.

2. Description of Related Art

The mechanical refrigeration equipment usually includes the following four main components: compressors, condensers, expansion devices and evaporators, wherein the evaporators are used to make refrigerant to absorb heat, to evaporate, to enter the compressor, and to be compressed. The commercially available evaporating devices are usually operated in three types: direct-expansion, flooded, and spraying heat exchanging systems.

The foresaid direct-expansion and flooded heat exchanging systems are heat exchangers combining a shell and inner tubes; the only difference between them is the fluid used for the shell side and the inner tubes. For direct-expansion heat exchanging systems, the target fluid for heat conduction flows through the shell side while the refrigerant flows in the inner tubes. The incompletely evaporating refrigerant in the tubes will cause the liquid refrigerant to be sucked into the compressor and further damage it. Therefore, the overall refrigerant in the evaporator must be evaporated completely and transformed into superheated vapor state to prevent the damage. Consequently, it may yet lower the quality of suction and increase power consumption of the compressor. As for a flooded system shown in FIG. 1, the target fluid flows in the inner tubes 12 while the refrigerant flows through the shell side. Since it is harder for the liquid refrigerant to be sucked by the compressor, there will be no liquid refrigerant around the inlet 112 of the compressor, thereby results in less power consumption.

However, the tubes have to be covered by liquid refrigerant, so it will not be high-effect until a large amount of refrigerant, supplied through the inlet 111, fully cover the inner tubes 12. However, the amount of the required refrigerant in flooded system is usually two times greater than that in a direct-expansion system, or even more. The total cost of a flooded system is higher and it is also harmful to the environment.

The refrigerant inlets of the aforementioned spraying system are designed in the upper portion of the shell, and the refrigerant is sprayed on the tubes surface by gravity or pressure. The heat of the target fluid inside the tubes is then to be exchanged with the sprayed refrigerant, and being taken away. Since the refrigerant covered the tubes surface is formed as a film that results in film boiling, the spraying system has a better heat exchange efficiency than pool boiling in flooded system. As a result, the spraying system consumes fewer refrigerant but has the same heat exchanging as flooded system. Therefore, spraying heat exchanging system is commonly used in the current markets. Such a system is not only able to overcome the disadvantages of the liquid refrigerant being sucked to the compressor by supplying overheated refrigerant to the inlets of compressors, but also to reduce the large amount of required refrigerant.

Referring to FIG. 2, the U.S. Pat. No. 5,839,294 disclosed a spraying heat exchanging system. The system consists of a spraying evaporation device body 21, an expansion valve 23, a compressor 24 and a condenser 25. The refrigerant is in state of liquid-vapor after passing through the expansion valve 23, and then led into spraying tubes 2111 of the body 21 through an inlet 211 so as to be sprayed on heat exchanging tubes surface 22. The refrigerant will proceed to the heat exchange with the heat exchanging tubes 22 and then evaporate into the refrigerant vapor that enters the compressor 24 through an outlet 212. However, the refrigerant in the liquid-vapor state is apt to distribute itself non-uniformly in the multi-tube spraying tubes 2111. In addition, in order to spray throughout, it is normally required to precisely control the pressure of the spraying tubes 2111 and to finely processing the poretherein. As a result, not only the manufacturing costs will be higher, but the quality will be affected by the complexity of the precise controlling and processing. Furthermore, there is another issue coming from the pressure difference between the spraying tubes and that of the body, in which case the refrigerant may easily overflow out of the body. To prevent this, welding or tube expansion techniques, which makes the whole system hard to be disassembled and maintained, have to be used to connect the spraying tubes and the body.

Referring to FIG. 3, the Taiwanese Patent No. M247805 disclosed an overflow-spraying heat exchanging system. The system 3 has a refrigerant inlet 311, a spraying device comprising an upper overflow plate 30a and a lower spraying plate 30b. The refrigerant overflows from the plate 30a to the plate 30b and is sprayed on heat exchanging tubes 32. After the refrigerant evaporates, the refrigerant vapor will pass through an opening 30c on the sides of the spraying device 30, and be transmitted to the compressor through an outlet 34. However, the outlet 34 and the spraying device 30 are too close to each other so that the refrigerant vapor may bring the liquid refrigerant together to the compressor through the outlet 34, which causes the problem of the liquid being sucked by the compressor.

FIG. 4 shows a heat exchanging system disclosed in the Taiwanese Patent No. I291541. The refrigerant in the system 4 are supplied from an inlet 40 to a spraying device 44, wherein openings of the spraying device 44 are facing toward heat exchanging tubes 42. The refrigerant vapor is then discharged through an outlet 46. However, the configuration may cause a non-uniformly spray if the spraying device 44 is not horizontally setup. In addition, the oversized spraying device 44 causes holdback for the refrigerant vapor to be transmitted into the compressor. Besides, it is difficult to disassemble such structures which increases the maintenance cost.

Therefore, it is desired to develop a spraying heat exchanging system, which has the advantages of spraying systems and overcomes the disadvantages of the aforementioned prior arts.

### SUMMARY OF THE INVENTION

The present invention provides a multi-tube spraying device, which achieves uniform spray by simple pressure controlling.

The present invention also provides a multi-tube spraying device, which enables liquid refrigerant to be supplied into the spraying tubes for uniform spray.

The present invention also provides a multi-tube spraying device, which ensures that the fluid supplied into the compressor is refrigerant vapor so that the damage to the compressor due to liquid compression can be reduced.

The present invention also provides a multi-tube spraying device, which increases the disassembly convenience and lowers the maintenance cost.

The present invention also provides a multi-tube spraying device, which allows the liquid refrigerant to have more room to flow while evaporating, thereby lowering the speed of refrigerant vapor's passing through the spraying device by enlarging the area of sucking channels inside the evaporator.

The present invention provides a multi-tube spraying device, comprising: a body having a closed vessel, a plurality of spraying tubes disposed in the upper part of the closed vessel, a plurality of heat exchanging tubes disposed in the lower part of the closed vessel, an outlet pipe for discharging refrigerant vapor, a connecting pipe introducing refrigerant vapor of a refrigerant source to the vessel. Besides, there is an liquid-vapor separator of the spraying device, which connects to the refrigerant source to separate the refrigerant vapor from liquid refrigerant therein, wherein the refrigerant vapor is introduced to the vessel through the connecting pipe of the body while the liquid refrigerant is introduced to the spraying tubes of the body, thereby proceeding to heat exchange with the heat exchanging tubes.

The multi-tube spraying device ensures that only liquid is introduced into the spraying tubes by disposing the liquid-vapor separator. Thus, the non-uniform refrigerant distribution caused by the liquid-vapor refrigerant flowing to the spraying tubes can be overcome. Besides, the connecting pipes also help the refrigerant vapor inside the liquid-vapor separator be led into the body. Along with the refrigerant vapor evaporated inside the body, it is discharged through the outlet pipes.

The multi-tube spraying device of the present invention can further include a pressure regulating valve disposed in the connecting pipe between the liquid-vapor separator and the body. It is used with the help of gravity of the liquid fluid itself to adjust the internal pressure of the liquid-vapor separator, and for controlling the spraying flux and speed of the liquid refrigerant.

The multi-tube spraying device of the present invention can further include a liquid receiver disposed between the body and the liquid-vapor separator. It is used to collect refrigerant into a collecting room, which connects the spraying tubes of the body and the liquid refrigerant outlet of the liquid-vapor separator.

With the liquid receiver, the refrigerant vapor can be collected in a room, and the refrigerant pressure in the room is the same as that inside the evaporator body. Therefore, it is not necessary to weld or tightly expand the tube with the tube sheet, so as to facilitate the disassembly process.

Moreover, the multi-tube spraying device of the present invention can comprise a plurality of bolts which are used for fixing the spraying tubes to the tube sheet and allow the spraying nozzles of the spraying tubes being aimed at the heat exchanging tubes.

### BRIEF DESCRIPTION OF DRAWINGS

The present invention can be more fully understood by reading the following detailed description of the preferred embodiments, with reference made to the accompanying drawings, in which

FIG. 1 to FIG. 4 are schematic diagrams showing the heat exchanging systems of the prior arts;

FIG. 5 is a schematic diagram of the multi-tube spraying device according to the present invention;

FIG. 6 is a section view of the multi-tube spraying device in FIG. 5; and

FIG. 7 is a side view of the multi-tube spraying device in FIG. 5.

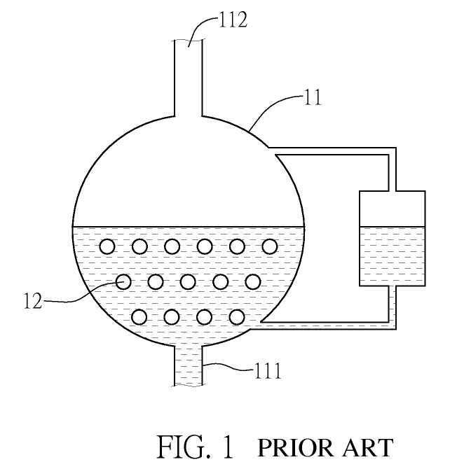

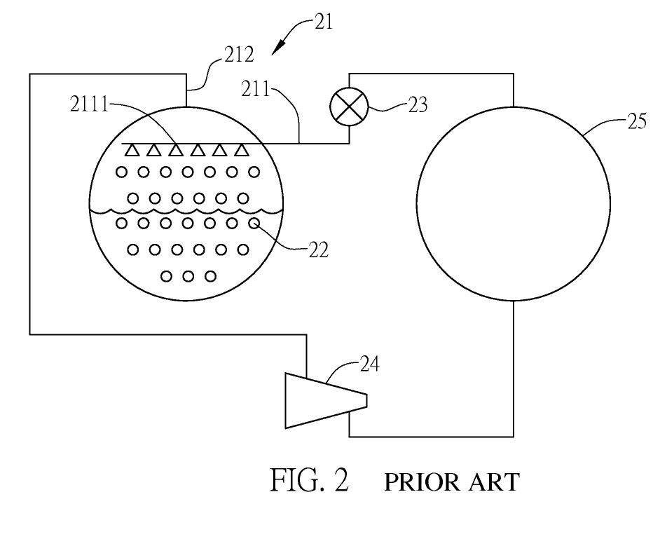

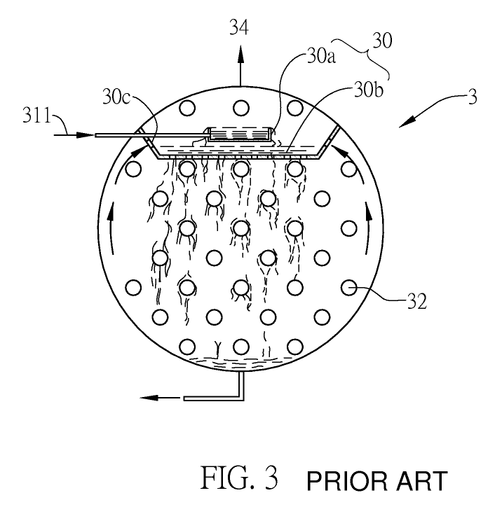

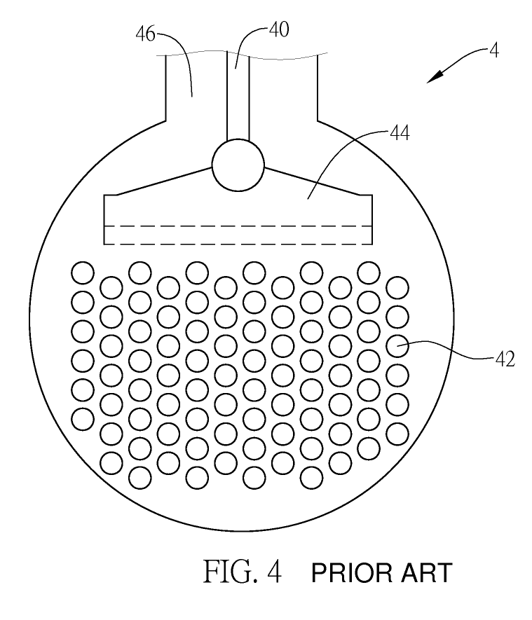

### DETAILED DESCRIPTION OF PREFERRED EMBODIMENTS

The specific embodiments are to be described to illustrate the present invention. These and other advantages or effects of the present invention can be easily appreciated by those ordinarily skilled in the art after reading the disclosure in the specification.

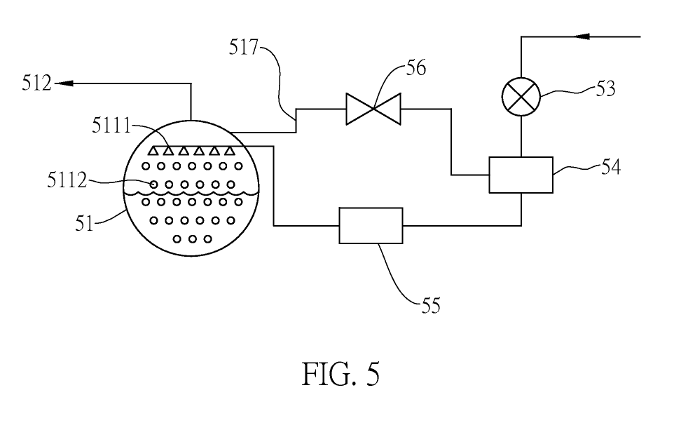

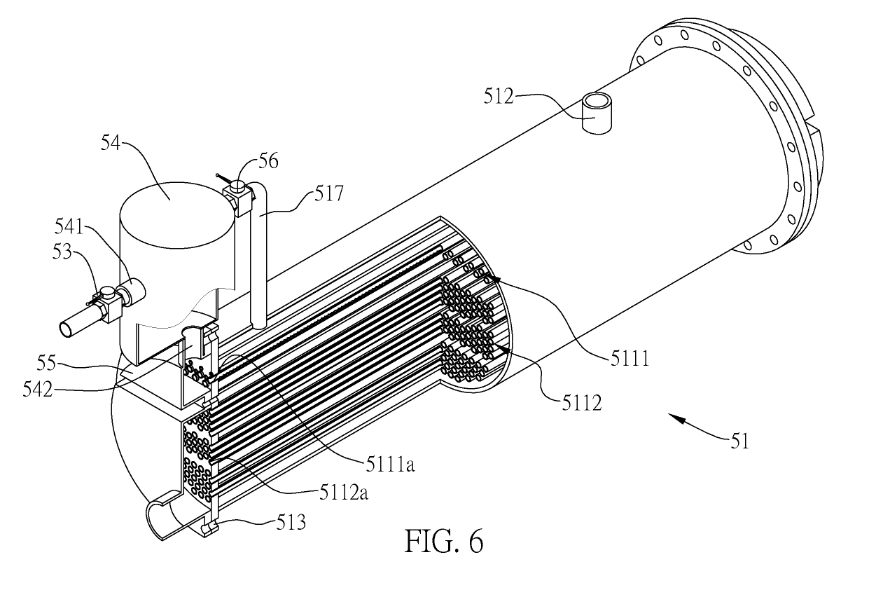

The schematic diagrams of the multi-tube spraying device according to the present invention are shown in FIGS. 5 and 6.

The basic component of the multi-tube spraying device is a body 51, comprising a first tube sheet 513 and a second tube sheet (not shown in FIGs.) disposed around the two ends of the body 51 respectively, an outlet pipe 512 for discharging refrigerant vapor from a vessel, a connecting pipe 517 for introducing the refrigerant vapor from a refrigerant source into the vessel, a plurality of openings 5111a and 5112a formed through the first tube sheet 513 and the second tube sheet, the vessel formed by the body 51 and the tube sheets, wherein a plurality of spraying tubes 5111 are disposed above a plurality of heat exchanging tubes 5112 in the vessel with a plurality of spraying nozzles (not shown in FIGs.) facing toward the heat exchanging tubes 5112. Both of the two ends of the spraying tubes 5111 are connected to the first tube sheet 513 and the openings 5111a of the second sheet, while both of the two ends of the heat exchanging tubes 5112 are jointed to the first tube sheet 513 and the openings 5112a of the second sheet.

In addition to the basic body component, the multi-tube spraying device according to a first aspect of embodying the present invention (not shown in FIGs.) further includes a liquid-vapor separator 54 having an inlet 541 for introducing in the liquid refrigerant, an outlet 542 for introducing out the liquid refrigerant to the body 51, and an output port (not shown in FIGs.) for outputting the refrigerant vapor to the body 51, wherein the inlet 541 introduces the refrigerant in a liquid-vapor state that passes through the expansion valve 53 into the liquid-vapor separator 54 so as to separate the fluid into the liquid and vapor refrigerant. The liquid refrigerant will then go through the outlet 542 and be led into the spraying tubes 5111 of the body 51, while the refrigerant vapor goes through the output port and be led into the body 51.

In a second aspect (not shown in FIGs) of embodying the present invention, the multi-tube spraying device besides the basic body component further includes a liquid receiver 55 formed on the side of the first tube sheet 513 for sealing the openings 5111a and providing a collecting room, which has an inlet connecting to a refrigerant source and an outlet connecting to the spraying tubes 5111 of the body 51 for collecting the liquid refrigerant in the collecting room and introducing it to the spraying tubes 5111.

As shown in FIG. 6, the multi-tube spraying device according to another aspect of embodying the present invention other than the basic body component further comprises a liquid-vapor separator 54 having an inlet 541 for introducing in the liquid refrigerant, an outlet 542 for introducing out the liquid refrigerant to the body 51, and an output port (not shown in FIGs.) for outputting the refrigerant vapor to the body 51, wherein the inlet 541 introduces the refrigerant fluid in a liquid-vapor mixture state that passes through the expansion valve 53 into the liquid-vapor separator 54 so as to separate the refrigerant into liquid and vapor state. The liquid refrigerant will then go through the outlet 542 and be led into the spraying tubes 5111 of the body 51, while the refrigerant vapor goes through the outlet port and be led into the body 51. It also includes a liquid receiver 55 disposed between the body 51 and the liquid-vapor separator 54, and formed on the side of the first tube sheet 513 for sealing the openings 5111a and providing a collecting room, which has an outlet 542 connecting an outlet 542 of the liquid-vapor separator 54 and the spraying tubes 5111 of the body 51 for introducing the liquid refrigerant to the spraying tubes 5111.

Additionally, the multi-tube spraying device as an embodiment of the present invention may further include a pressure regulating valve 56 disposed in the connecting pipe 517 between the body 51 and the liquid-vapor separator 54, when equipped with a liquid-vapor separator. The pressure regulating valve is used for controlling the internal pressure of the liquid-vapor separator 54.

Furthermore, in the multi-tube spraying device as the above-mentioned first or third aspect of embodying the present invention, the connecting pipe 517 is used to balance the internal pressure between the body 51 and the liquid-vapor separator 54. The internal pressure depends the discharge of refrigerant vapor and the spraying rate of liquid refrigerant. If the internal pressure needs to be controlled more precisely, the spraying nozzles of the spraying tubes 5111 are too small or the difference in height between the liquid-vapor separator 54 and body 51 is not adequate for example, the pressure regulating valve 56 can be disposed in the connecting pipe 517 so as to adjust the spraying flux.

FIG. 5 shows a system using the multi-tube spraying device according to the third aspect of the present invention. After passing through the expansion valve 53, the refrigerant will be introduced into the liquid-vapor separator 54 and separated into vapor and liquid. Next, the liquid refrigerant will be introduced into the liquid receiver 55, collected into a vessel (not shown), and then diverted into the spraying tubes 5111 of the body 51. At the same time, the refrigerant vapor passes through the pressure regulating valve 56 and then the connecting pipe 517, and finally into the body 51. After that, the refrigerant in the spraying tubes 5111 are sprayed on the surface of heat exchanging tubes 5112 and liquid film is formed. The film will evaporate into vapor after heat exchanging with the target fluid in the heat exchanging tubes 512. Lastly, the refrigerant vapor in the body 51, together with the refrigerant vapor led in by the pressure regulating valve 56, will be discharged out of the body 51 through the outlet pipe 512.

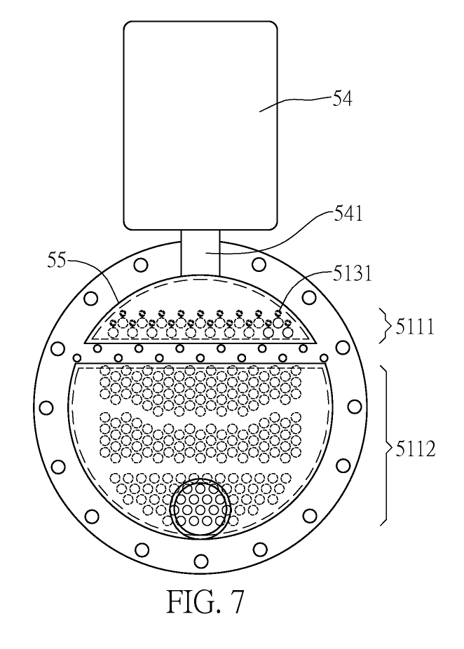

FIG. 7 is a side view of the multi-tube spraying device according to the third aspect of embodying the present invention, wherein the openings 5111a and the spraying tubes 5111 are loosely jointed in corresponding shapes so that the device can be disassembled easily. Alternatively, a plurality of positioning bolts 5131 can be used for fixedly jointing different parts of the device so as to direct the spraying nozzles of the spraying tubes 5111 toward the positions of the heat exchanging tubes 5112.

Therefore, by providing the liquid receiver 55 and the positioning bolts 5131, the spraying tubes 5111 can be disassembled more easily, and the refrigerant overflow problems can be avoided.

Besides, the spraying tubes 5111 or the heat exchanging tubes 5112 according to the multi-tube spraying device of the present invention can be arranged in a staggered or a parallel manner, and in a plural or a singular manner. Such tubes can also be of linear or curved shapes. The types and the arrangement of the tubes depend on practical requirements and are not limited to those disclosed in the embodiments or in the accompanied drawings.

The foregoing descriptions of the detailed embodiments are only illustrated to disclose the features and functions of the present invention and not restrictive of the scope of the present invention. It should be understood to those skilled in the art that all modifications and variations according to the tactic and principle in the disclosure of the present invention should fall within the scope of the appended claims.

What is claimed is:

1. A multi-tube spraying device, comprising:
a body having a closed vessel and comprising:
a plurality of spraying tubes disposed in an upper part of the closed vessel;
a plurality of heat exchanging tubes disposed in a lower part of the closed vessel;
an outlet pipe for discharging refrigerant vapor; and
a connecting pipe for introducing the refrigerant vapor of a refrigerant source into the closed vessel; and
a liquid-vapor separator connected to the refrigerant source for separating the refrigerant vapor from liquid refrigerant therein, wherein the refrigerant vapor is introduced into the closed vessel through the connecting pipe of the body, and the liquid refrigerant is introduced into the spraying tubes of the body, thereby proceeding to heat exchange with a target fluid in the heat exchanging tubes.

2. The multi-tube spraying device of claim 1, further comprising a pressure regulating valve disposed in the connecting pipe between the liquid-vapor separator and the body for adjusting internal pressure of the liquid-vapor separator and controlling spraying flux of the liquid refrigerant.

3. The multi-tube spraying device of claim 1, wherein the liquid-vapor separator has an expansion valve on a side of the refrigerant source.

4. The multi-tube spraying device of claim 1, wherein both ends of each of the spraying tubes and the heat exchanging tubes are respectively connected in a manner of loose jointing in corresponding shapes to tube sheets which are individually disposed in the vicinity of each of two ends of the body.

5. The multi-tube spraying device of claim 1, wherein the spraying tubes are designed as linear or curved shapes, and are arranged in a line or in a plurality of lines, and are arranged in a staggered manner when arranged in a plurality of lines.

6. The multi-tube spraying device of claim 1, wherein the heat exchanging tubes are designed as linear or curved shapes, and are arranged in a line or in a plurality of lines, and are arranged in a staggered manner when arranged in a plurality of lines.

7. The multi-tube spraying device of claim 1, wherein the spraying tubes are fixed with a plurality of bolts to tube sheets which are individually disposed in vicinity of each of two ends of the body.

8. The multi-tube spraying device of claim 1, wherein the target fluid is water or other non-freezing aqueous solutions.

9. A multi-tube spraying device, comprising:
a body having a closed vessel and comprising:
a plurality of spraying tubes disposed in an upper part of the closed vessel;
a plurality of heat exchanging tubes disposed in a lower part of the closed vessel;
an outlet pipe for discharging refrigerant vapor; and
a connecting pipe for introducing the refrigerant vapor of a refrigerant source into the closed vessel; and
a liquid receiver having a collecting room for refrigerant, wherein the collecting room has an inlet connected to the refrigerant source and an outlet connected to the spraying tubes of the body.

10. The multi-tube spraying device of claim 9, wherein the liquid collecting device has an expansion valve on a side of the inlet.

11. The multi-tube spraying device of claim 9, wherein both ends of each of the spraying tubes and the heat exchanging tubes are respectively connected in a manner of loose jointing in corresponding shapes to tube sheets which are individually disposed in the vicinity of each of two ends of the body.

12. The multi-tube spraying device of claim 9, wherein the spraying tubes are designed as linear or curved shapes, and are arranged in a line or in a plurality of lines, and are arranged in a staggered manner when arranged in a plurality of lines.

13. The multi-tube spraying device of claim 9, wherein the heat exchanging tubes are designed as linear or curved shapes, and are arranged in a line or in a plurality of lines, and are arranged in a staggered manner when arranged in a plurality of lines.

14. The multi-tube spraying device of claim 9, wherein the spraying tubes are fixed with a plurality of bolts to tube sheets which are individually disposed in vicinity of each of two ends of the body.

15. A multi-tube spraying device, comprising:
a body having a closed vessel, and comprising:
a plurality of spraying tubes disposed in an upper part of the closed vessel;
a plurality of heat exchanging tubes disposed in a lower part of the closed vessel;
an outlet pipe for discharging refrigerant vapor, and
a connecting pipe for introducing refrigerant vapor of a refrigerant source to the closed vessel;
a liquid-vapor separator connected to the refrigerant source to separate the refrigerant vapor from liquid refrigerant therein, wherein the refrigerant vapor is introduced to the closed vessel through the connecting pipe of the body, and the liquid refrigerant is introduced into the spraying tubes of the body; and
a liquid receiver having a collecting room to collect the liquid refrigerant, wherein the collecting room has an inlet connected to the refrigerant source and an outlet connected to the spraying tubes of the body.

16. The multi-tube spraying device of claim 15, wherein refrigerant from the refrigerant source is introduced into the liquid-vapor separator through an expansion valve.

17. The multi-tube spraying device of claim 15, wherein both ends of each of the spraying tubes and the heat exchanging tubes are respectively connected in a manner of loose jointing in corresponding shapes to tube sheets which are individually disposed in the vicinity of each of two ends of the body.

18. The multi-tube spraying device of claim 15, wherein the spraying tubes are designed as linear or curved shapes, and are arranged in a line or in a plurality of lines, and are arranged in a staggered manner when arranged in a plurality of lines.

19. The multi-tube spraying device of claim 15, wherein the heat exchanging tubes are designed as linear or curved shapes, and are arranged in a line or in a plurality of lines, and are arranged in a staggered manner when arranged in a plurality of lines.

20. The multi-tube spraying device of claim 15, wherein the spraying tubes are fixed with a plurality of bolts to tube sheets which are individually disposed in vicinity of each of two ends of the body.
